(19) United States
(12) Patent Application Publication
(10) Pub. No.: US 2011/0246631 A1
(43) Pub. Date: Oct. 6, 2011

(54) ASSIGNING AND REMOVING CONNECTIONS UTILIZING ONLINE EVENT TRACKING

(76) Inventors: Mary G. Baker, Palo Alto, CA (US); Ian N. Robinson, Pebble Beach, CA (US)

(21) Appl. No.: 12/751,115

(22) Filed: Mar. 31, 2010

(51) Int. Cl. G06F 15/173

(52) U.S. Cl. 709/223

(57) ABSTRACT

In one embodiment, a group is provided and a connection is assigned to the group. Online events involving a user and the connection are tracked. The connection is removed from the group upon passage of a period.

### BACKGROUND

Various web sites and applications facilitate communication and information sharing between users that have established trust-based relationships (e.g. connections with friends, colleagues, customers and business partners). For example, a number of social networking sites and applications provide opportunities for the sharing of personal and professional information and collaboration among connected members. Some collaborative web sites and applications provide browser-based content management tools that promote information-sharing across an organization, granting permissions based on connections between members. Conferencing web sites may also utilize trust based relationships as they provide web conferencing, desktop sharing and other applications to users.

### BRIEF DESCRIPTION OF THE DRAWINGS

The accompanying drawings illustrate various embodiments and are a part of the specification. The illustrated embodiments are merely examples and do not limit the scope of the claims. Throughout the drawings, identical reference numbers designate similar, but not necessarily identical elements.

FIG. 1 depicts an example environment in which various embodiments may be implemented.

FIG. 2 depicts an example of a connection manager according to an embodiment.

FIG. 3 depicts an implementation of the connection manager of FIG. 2 according to an embodiment.

FIGS. 4-5 are example flow diagrams depicting embodiments of a method to assign and remove connections from groups utilizing online event tracking.

FIGS. 6-8 depict example user interface screen shots, according to embodiments.

The same part numbers designate the same or similar parts throughout the figures.

### DETAILED DESCRIPTION OF EMBODIMENTS

Over a period of time the relationship between a first user of a web site or application and a second user with whom the first user had entered into a trust-based relationship may change to the point that the first user no longer desires to collaborate or share information with the second user. In such a case the first user may simply remove the second user from a set of individuals that enjoy information sharing, and/or conferencing privileges. However, abruptly removing a person or entity that a first user has identified as a connection in an online social network (sometimes referred to as “unfriending”), or removing a connection that is a colleague from a collaboration or conferencing work group, may be viewed by the connection as aggressive and impolite. Embodiments described below were developed in an effort to provide a method and system to assign and remove connections from groups utilizing online event tracking.

The following description is broken into sections. The first, labeled “Environment”, describes an example environment in which embodiments may be implemented. The second section, labeled “Components”, describes various physical and logical components utilized to implement various embodiments. The third section, labeled as “Operation”, describes various example embodiments of a method to assign and remove connections from groups utilizing online event tracking. The fourth section, labeled “Example”, describes example user interfaces that may be implemented in various embodiments.

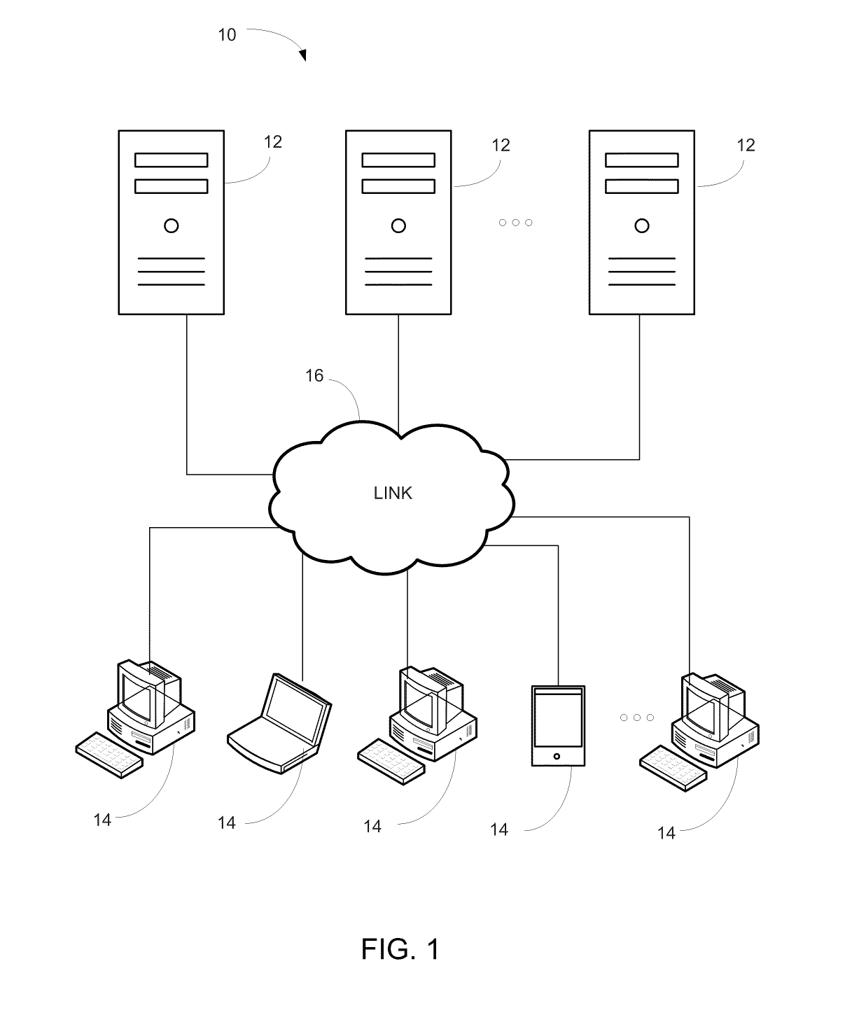

ENVIRONMENT: FIG. 1 depicts an example environment 10 in which various embodiments may be implemented. Environment 10 is shown to include servers 12 and client devices 14 interconnected via link 16.

Servers 12 represent generally any computing device capable of serving content to, and receiving content from, a client 14 via link 16. The term content refers to visual and audible information that can be presented to and received from a user of a client 14. Examples include text, still, images, audio, and video. Content can also include instructions designed to be processed by a client 14. Examples include HTML code and various scripts. Servers 12 may be one or more servers hosted by an online or web based service that facilitates sharing of information, collaboration, conferencing and/or other online activities utilizing trust-based relationships (hereinafter an “Online Collaboration Service or OCS”). In an example, servers 12 may be utilized by an OCS to host web pages and run applications that facilitate information sharing via email, instant messaging, work groups, document-sharing, conferencing and/or make available third party applications. As used in this specification and the appended claims, an “application” includes a program stored in memory that presents a computer with instructions to accomplish a task.

Each client device 14 represents generally any computing device capable of requesting content from, and sending content to, servers 12 via a link 16. Client devices 14 are also responsible for receiving and processing responses to the requests. As used in this specification and the appended claims, “processing” includes executing instructions in memory to perform some transformation and/or computation on data in the computing device's memory. Processing may include displaying visual content such as text, images, and motion video on a monitor as well as broadcasting audio content via one or more speakers. Example client devices include desktop computers, laptop computers, smart phones, cell phones, personal digital assistants, net-books, digital media players, and the like.

Link 16 represents generally one or more of a cable, wireless, fiber optic, or remote connection via a telecommunication link, an infrared link, a radio frequency link, or any other connector or system that provides electronic communication. Link 16 may represent an intranet, the internet, or a combination of both. The paths followed by link 16 between servers 12 and client devices 14 as depicted in FIG. 1 represent the logical communication paths between these devices, not necessarily the physical paths between the devices.

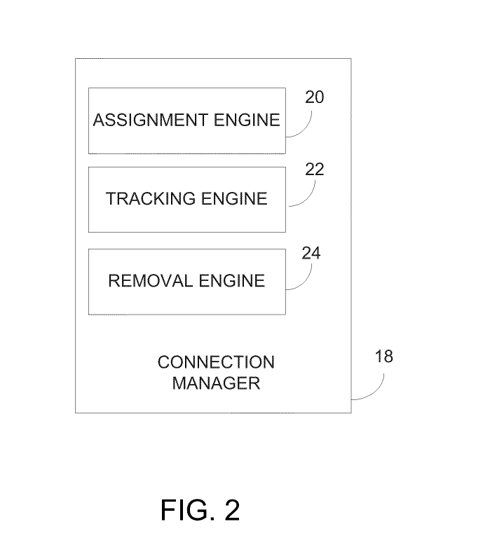

COMPONENTS: FIG. 2 depicts an example of a connection manager 18. Connection manager 18 represents generally any combination of hardware and programming configured for use in assigning and removing connections from groups utilizing online event tracking. In the example of FIG. 2, connection manager 18 is shown to include an assignment engine 20, a tracking engine 22 and a removal engine 24.

Assignment engine 20 represents generally any combination of hardware and programming configured to provide a group and to assign a connection to the group. As used in this specification and the appended claims, “group” includes a set, the set including a user and any connections assigned to the group by the user. (As used in this specification and the appended claims, users that are in an online trust-based relationship that grants access and/or sharing privileges are “connected” to each other, and each connected user is a “connection” with respect to the other.) Such a trust relationship may be based on prior real-world or online experiences between the first and second users or the trust relationship may be created indiscriminately.

Some OCS web sites and applications use the word “connection” to designate a trust relationship. Other OCS web sites and applications may use alternative words to demonstrate an online connection. For example, Facebook® may refer to a “friend, Twitter® may refer to a “follower” and Classmates.com® may refer to a “classmate” to indicate a trust relationship. As used in this specification and the appended claims, “connection” includes these and any other designations of trust utilized by these and other OCS services. In an embodiment, an OCS web site or application may provide a user with an option of establishing connections based on a plurality of defined trust relationships, all of which may be considered equivalent to a “connection” for purposes of this specification and the appended claims.

In an example, a first user may send an invitation to a second user to be a connection. If the second user accepts the invitation, a connection is established. This connection may enable the first user to access or add to some or all of the content of the second user's personal page (e.g. status postings, pictures, and lists of other connections) and vice versa. OCS services may provide a variety of ways for “connections” to interact, e.g. e-mail, instant messaging, video conferencing, document sharing and accessing each other's personal web pages.

In an embodiment, the assignment engine 20 provides a single group that is a general group for all connections. In an embodiment, the assignment engine 20 provides a plurality of groups for the user to choose from based upon relationships, such as “family”, “extended family”, “friends”, “close friends”, “coworkers”, “team”, “miscellaneous” and the like. In embodiments the plurality of groups may be pre-defined, an in other embodiments the groups may be named and provided at the direction of the user. In an example, the assignment engine 20 may provide a group that is specific to an online project that the user is working on with other users. In another example, the assignment engine 20 may provide a plurality of groups for the user to use to assign connections based upon a common interest, such as a profession or hobby, or a common history, such as a school attended or an employer.

Tracking engine 22 represents generally any combination of hardware and programming configured to track online events involving a user and a connection. As used in this specification and the appended claims, an “online event” includes an interaction between a user and a connection via computers connected by a link, including but not limited to interactions via a network, intranet or internet. An online event may include, but is not limited to, a posting of content to a web page, an accessing of web page content, a sending or a receiving of an email or instant message, initiation or receipt of a telephone call, and/or a change to an online project. As used in this specification and the appended claims, an “online project” includes a project or collaborative task conducted in whole or in part via computers connected by a link, including but not limited to interactions via a network, intranet or internet. Examples of a “change to an online project” include an addition to or subtraction from an online project team, a suspension of an online project, a termination of an online project or a completion of an online project. In an embodiment, the online events tracked occur within a first application. In another embodiment the online events tracked occur within a plurality of applications. For example, a tracking engine 22 may be configured to track emails sent within a multitude of social networking applications, and to count an email sent in any of the applications as an online event.

In an embodiment, the tracking engine 22 is additionally configured to receive an election from a user to participate in a removal program. As used in this specification and the appended claims, a “removal program” includes any combination of hardware and programming configured to remove connections from groups utilizing online event tracking. In an example, the tracking engine 22 is operable to initiate the tracking of online events involving the user and the user's connections after receiving an affirmative election from the user to participate in a removal program. In another embodiment, the tracking engine 22 is configured to provide to the user an opportunity not to participate in a removal program. For example, the tracking engine 22 may be configured to initiate the tracking of online events involving the user and the user's connections absent receiving an instruction from the user not to participate in a removal program.

Removal engine 24 represents generally any combination of hardware and programming configured to remove a connection from a group upon passage of an aging period associated with an online event. For purposes of this specification and the appended claims, an aging period includes a period of time that is defined within an application. In an embodiment, the aging period is a defined period of time after the occurrence of an online event. In an example, the removal engine 24 may be configured to remove a connection from a group upon the passage of an aging period of one year after the last online event within a certain social networking application, wherein online events tracked within that application include emails sent and received, wall text postings, photograph uploads or downloads, and product purchases. In another example, the removal engine 24 may be configured to remove a connection from a group upon the passage of an aging period of one year after the completion of a specific online project that involves the user and the connection.

In an embodiment, the removal engine 24 is additionally configured to, after removing a connection to from a first group after an aging period associated with an online event, move the connection to a second group. The second group may be configured such that members of that second group are afforded less access to the user (e.g. less opportunity to access information posted by the user, to post information such that it may be accessed by the user and/or less opportunity to communicate with the user). In an example, a user assigns connection “Jenny” to a general group that affords maximum access to the user (e.g. the ability to access all content posted by the user and to the ability to email and schedule video conferences with the user). In an example an aging period associated with an online event may be set as passage of a six month time period since the last video conference involving the user and connection Jenny. Upon passage of the aging period in this example, the removal engine 24 removes connection Jenny from the general group, and moves connection Jenny to a second group. The second group is restricted in comparison to the general group in that Jenny can still send email to the user, but she can no longer schedule a video conference with the user.

In an embodiment, the removal engine 24 is configured to alert a user of an impending removal event. In an example, a user assigns connections who worked with the user as a team on a “Project Alpha” to a “Project Alpha Group”. A removal event in this example is defined as passage of ninety days following termination of an online project. In this example, the user is alerted on the eightieth day that unless the user intervenes the user's connections will be removed from the “Project Alpha Group” and moved to a distinct “General Connections Group” that affords the connection less access to the user's postings and less options to communicate with the user. In another example, a removal event is established as a departure of a connection from the Project Alpha team. In this example, a user may be alerted that unless the user intervenes within a specified time period the departing connection will be removed from the “Project Alpha Group”. In an embodiment the departing connection may be moved to a distinct “Past Team Members Group” that does not afford members with access to Project Alpha confidential information.

In an embodiment, the removal engine 24 may be configured to invite a user to adjust the aging period prior to removing a connection from a group because of the passage of the aging period. In an example, a user assigns connections to an “Extended Family” group. The removal event for a connection may be established as passage of twelve months following the last email or other online interaction with that connection. The removal engine 24 may be configured to send, on the eleventh month following the last online interaction between a user and a connection, an email to the user that includes an offer to adjust the aging period so as to extend the aging period for an additional twelve month period.

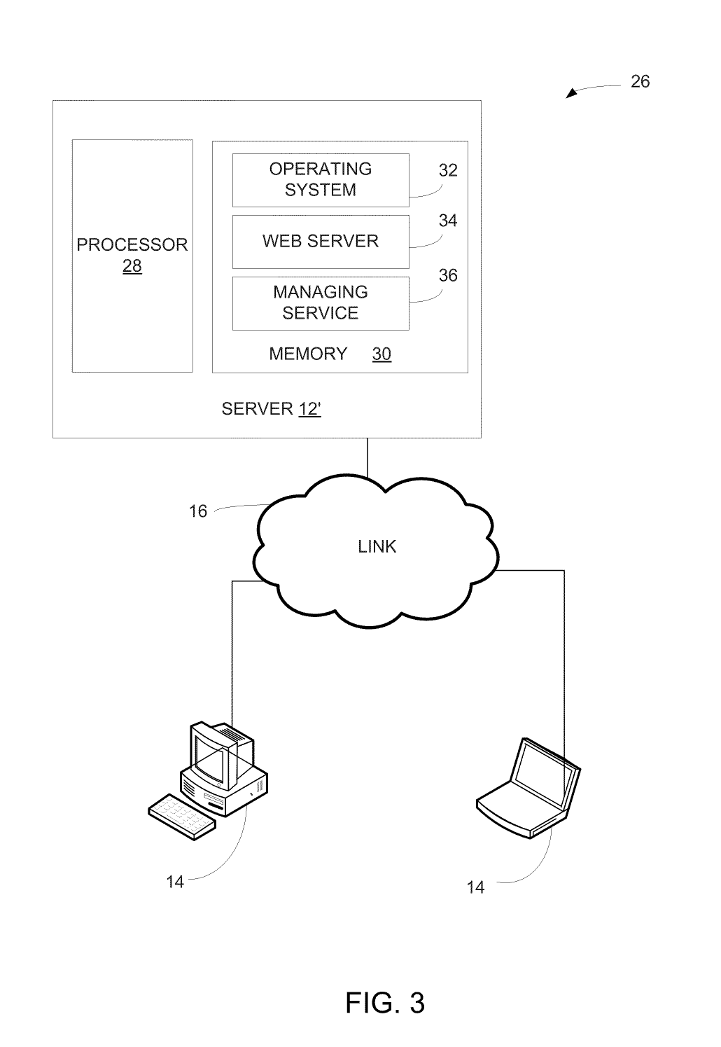

Connection manager 18 may be implemented in a number of environments, such as environment 26 of FIG. 3. Environment 26 includes client devices 14 and server 12′ interconnected via link 16. In an embodiment, server 12′ is shown to include processor 28 and a memory 30. Processor 28 represents generally any device capable of executing program instructions stored in memory 30. Memory 30 represents generally any memory configured to store program instructions and other data. Memory 30 is shown to include operating system 32, web server 34 and managing service 36. Operating system 32 represents generally any software platform on top of which other programs or applications such as the managing service 36 run. Examples include Linux® and Microsoft Windows®.

Web server 34 in combination with managing service 36 represent generally any programming that, when executed, implements the functionality of the connection manager 18 of FIG. 2. In an embodiment, managing service 36, when executed by processor 28, is responsible for providing a group and assigning a connection to the group. A single group may be provided for all connections, or a plurality of groups may be provided for the user to choose from. Online events involving a user and a connection are tracked. Online events may include, but are not limited to a posting of content to a web page, an accessing of web page content, a sending or a receiving of an email or an instant message, initiation or receipt of a telephone call, and/or receiving notice of a change to an online project. Online events may be tracked within a single application, or within a plurality of applications. A connection is removed from a group upon passage of an aging period associated with an online event. In an embodiment, the connection may be moved to a second group, the second group configured such that members of that second group are afforded less access to the user (e.g. less opportunity to access information posted by the user, to post information such that it may be accessed by the user and/or to communicate with the user).

In foregoing discussion, various components were described as combinations of hardware and programming. Such components may be implemented in a number of fashions. In one example, the programming may be processor executable instructions stored on tangible memory media and the hardware may include a processor for executing those instructions. Thus, certain elements operating on the same device may share a common processor and common memory media.

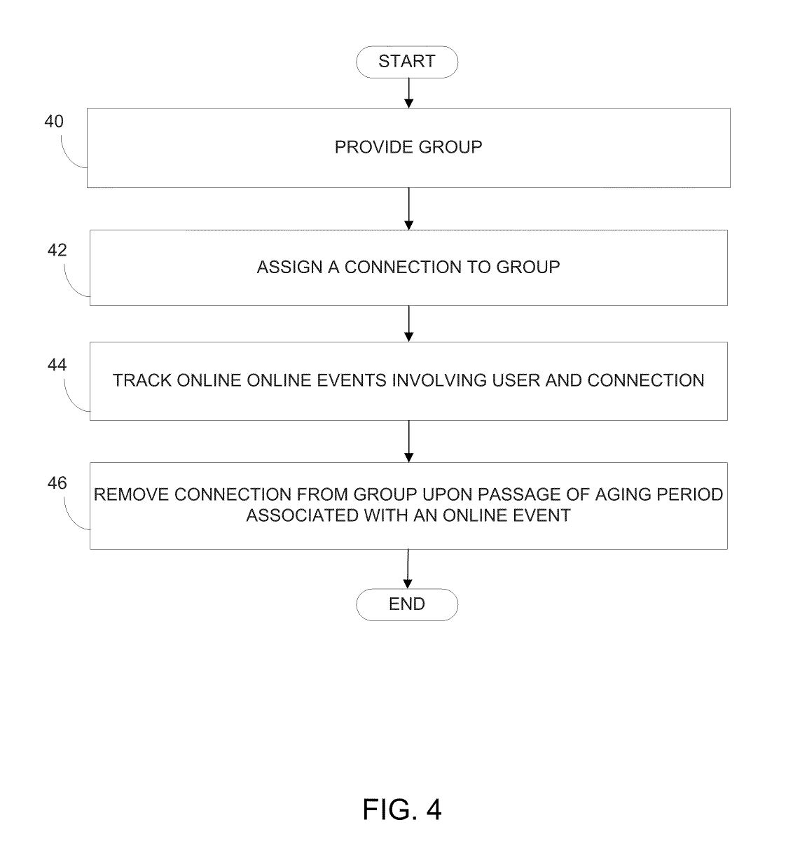

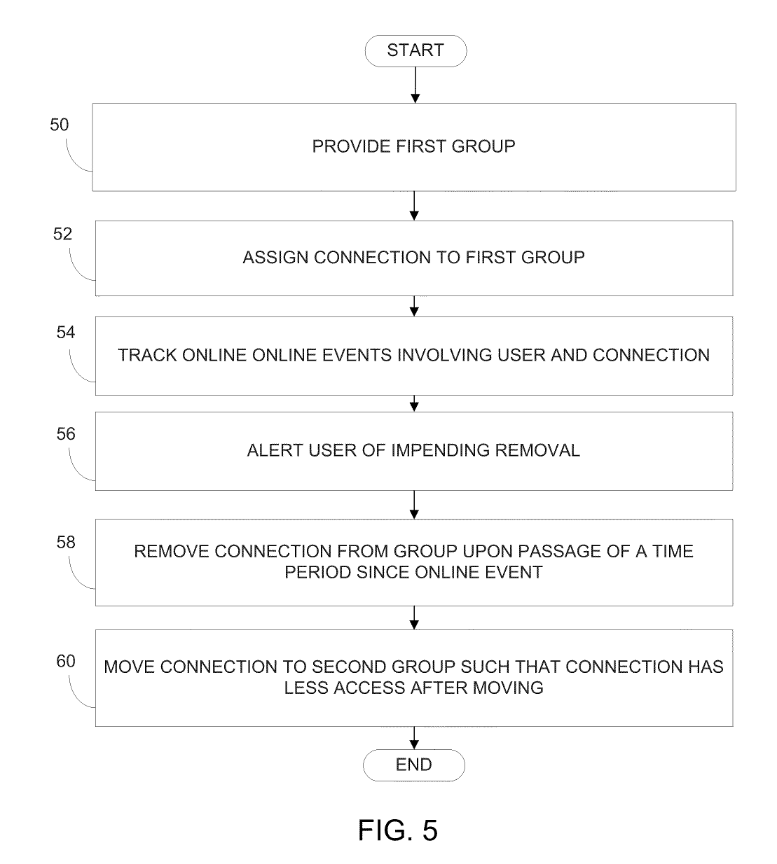

OPERATION: FIGS. 4 and 5 are example flow diagrams depicting example embodiments of a method to assign and remove connections from groups utilizing online event tracking. In discussing FIGS. 4 and 5, reference may be made to the diagrams of FIGS. 1-3 to provide contextual examples. Implementation, however, is not limited to those examples.

Starting with FIG. 4, a group is provided (block 40). A connection is assigned to the group (block 42). Referring back to FIG. 2, the assignment engine 20 may be responsible for implementing blocks 40 and 42. In an embodiment, the assignment engine provides a single group that is a general group for all connections. In another embodiment, the assignment engine provides a plurality of pre-defined groups for the user to choose from based upon relationships, such as “family”, “extended family”, “friends”, “close friends”, “coworkers”, “team”, “miscellaneous” and the like. In an example, the assignment engine may provide a group that is specific to an online project that the user is working on with other users. In another example, the assignment engine may provide a plurality of groups for the user to use to assign connections based upon a common interest, such as a profession or hobby, or a common history, such as a school attended or an employer.

Continuing with the flow diagram of FIG. 4, an online event involving a user and the connection is tracked (block 44). Referring back to FIG. 2, the tracking engine 22 may be responsible for implementing block 44. An online event may include, but is not limited to, a posting of content to a web page, an accessing of web page content, a sending or a receiving of an email or instant message, initiation or receipt of a telephone call, and/or a change to an online project. In an embodiment, the online events tracked occur within a first application. In another embodiment the online events tracked occur within a plurality of applications. For example, a tracking engine 22 may be configured to track emails sent within a multitude of social networking applications, and to count an email sent in any of the applications as an online event. In an embodiment, the tracking engine 22 is additionally configured to receive an election from a user to participate in a removal program. In an embodiment, the tracking engine 22 is additionally configured to provide to the user an opportunity not to participate in a removal program.

Continuing with the flow diagram of FIG. 4, the connection is removed from the group upon passage of an aging period associated with an online event (block 46). Referring back to FIG. 2, the removal engine 24 may be responsible for implementing block 46. In an embodiment, the aging period is a specified period of time after the occurrence of an online event, which online event may include an email sent or received, a wall text posting, a photograph upload or download, and/or a product purchase.

Moving on to FIG. 5, in a particular implementation, a group is provided (block 50). A connection is assigned to the group (block 52). Referring back to FIG. 2, the assignment engine 20 may be responsible for implementing blocks 50 and 52.

Continuing with the flow diagram of FIG. 4, an online event involving a user and the connection is tracked (block 54). Referring back to FIG. 2, the tracking engine 22 may be responsible for implementing block 54.

Continuing with the flow diagram of FIG. 4, the user is alerted of an impending removal event (block 56). Referring back to FIG. 2, the removal engine 24 may be responsible for implementing block 56. In an embodiment, the alerting may be accompanied by an offer to the user to adjust the aging period.

Continuing with the flow diagram of FIG. 4, the connection is removed from the group upon passage of a time period since an online event (block 58). Referring back to FIG. 2, the removal engine 24 may be responsible for implementing block 58.

Continuing with the flow diagram of FIG. 4, the connection is moved to a second group such that the connection has less access after the moving (block 60). Referring back to FIG. 2, the removal engine 24 may be responsible for implementing block 60. In an embodiment, the second group may be configured such that members of that second group are afforded less access to the user (e.g. less opportunity to access information posted by the user, to post information such that it may be accessed by the user and/or less opportunity to communicate with the user).

### Examples

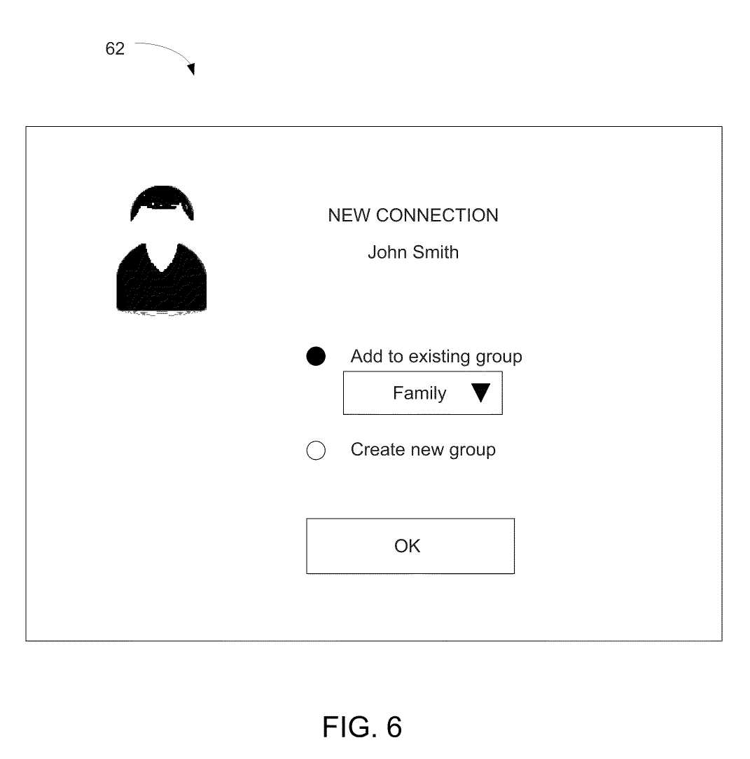

The diagrams of FIGS. 6-8 depict example user interface screen shots, according to embodiments.

FIG. 6 is a screen shot of a user interface 62 that, in an embodiment, may be presented to a user by a web server via a browser window, the browser window to appear on a web page that is provided by a managing service. In this example, an instruction to assign a new connection (“John Smith”) to a group is received from a user via radio button selection. In embodiments the user is invited to select radio buttons by mouse-clicking the radio buttons or by contacting a touch-screen. In this example, an instruction is received from the user to add the new connection to the existing group “Family”. An instruction to assign the new connection to another group could be received from the user, by virtue of the user selecting a drop down menu that lists other available groups.

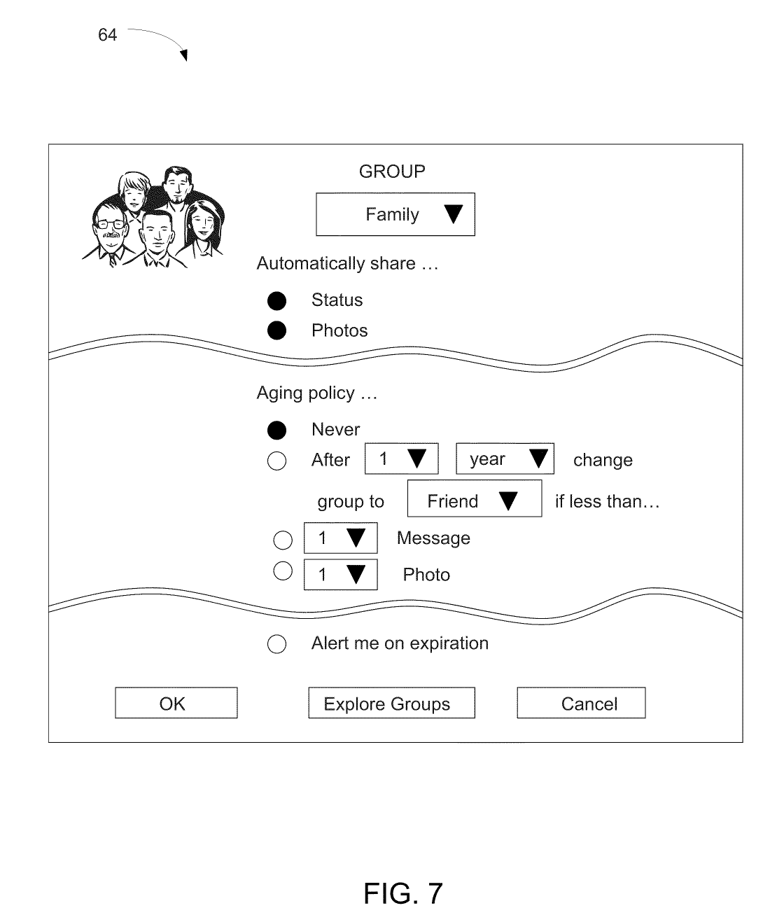

FIG. 7 is a screen shot of a user interface 64 that, in an embodiment, may be presented to a user. In an embodiment the user interface 64 might be provided to the user by web server via a browser window, the browser window to appear on a web page that is provided by a managing service. In this example, an instruction to establish sharing rights and an aging policy for the group “Family” is received from the user. Instructions with respect to the rights and policies for groups other than “Family” could be received from the user via a drop down menu. In this example an instruction is received that connections within the group “Family” are permitted to access user status updates and user photos. In this instance an instruction is received from the user that connections in the “Family” group not are not to be removed by a removal program.

In another example, instructions to create a group named “Extended Family”, and to establish a sharing policy that connections within the Extended Family group may access photos but not status updates, may be received from the user. An instruction may be received from a user to establish an aging policy that a connection assigned to the Extended Family group will moved to a “Friends” group if there is no messaging interaction between the user and the connection, or no viewing of user's photos by the connection, within an aging period of one year. In this example aging period instruction options are presented to the user via drop down menus. In this embodiment, an instruction that an alert be sent upon the occurrence of impending removal event may also be received from the user.

In this embodiment, an instruction to provide details regarding the triggering events (e.g. frequency and/or details of messages, viewing of photos, etc.) may be received from the user by virtue of the user selecting an “Explore Groups” option.

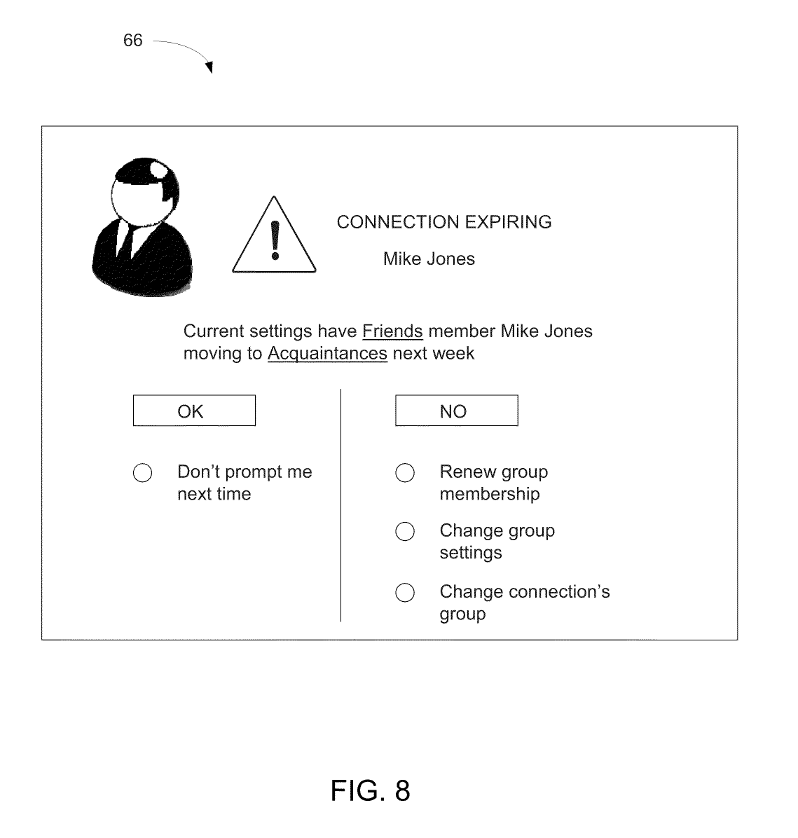

FIG. 8 is a screen shot of a user interface 66 that, in an embodiment, may be presented to a user. In an embodiment the user interface 66 might be provided to the user by web server via a browser window, the browser window to appear on a web page that is provided by a managing service. In this example an alert is sent informing a user that, pursuant to current settings, connection “Mike Jones” is due to be removed from a “Friends” group to an “Acquaintances” group next week. In this embodiment, the user is given an opportunity to agree or disagree with the removal. In this example, a user that disagrees is given options to instruct that connection “Mike Jones” be renewed, as a member of the Friend group, that group settings be changed, or that connection Mike Jones be moved to another group.

### CONCLUSION

The diagrams of FIGS. 1-3 are used to depict example environments in which various embodiments may be implemented. Implementation, however, is not so limited. FIG. 1-5 shows the architecture, functionality, and operation of various embodiments. Various components illustrated in FIGS. 2-5 are defined at least in part as programs. Each such component, portion thereof, or various combinations thereof may represent in whole or in part a module, segment, or portion of code that comprises executable instructions to implement any specified logical function(s). Each component or various combinations thereof may represent a circuit or a number of interconnected circuits to implement the specified logical function(s).

Also, the present disclosure may be embodied in any computer-readable media for use by or in connection with an instruction execution system such as a computer/processor based system or an ASIC (Application Specific Integrated Circuit) or other system that can fetch or obtain the logic from computer-readable media and execute the instructions contained therein. “Computer-readable media” can be any media that can contain, store, or maintain programs and data for use by or in connection with the instruction execution system. Computer readable media can comprise any one of many physical media such as, for example, electronic, magnetic, optical, electromagnetic, or semiconductor media. More specific examples of suitable computer-readable media include, but are not limited to, a portable magnetic computer diskette such as floppy diskettes or hard drives, a random access memory (RAM), a read-only memory (ROM), an erasable programmable read-only memory, or a portable compact disc.

Although the flow diagrams of FIGS. 4-5 show specific orders of execution, the order of execution may differ from that which is depicted. For example, the order of execution of two or more blocks may be scrambled relative to the order shown. Also, two or more blocks shown in succession may be executed concurrently or with partial concurrence. All such variations are within the scope of the present disclosure.

The preceding description has been presented only to illustrate and describe embodiments and examples of the principles described. This description is not intended to be exhaustive or to limit these principles to any precise form disclosed. Many modifications and variations are possible in light of the above teaching.

What is claimed is:

1. A method, comprising:
providing a first group;
assigning a connection to the first group;
tracking online events involving a user and the connection; and
removing the connection from the first group upon passage of an aging period associated with an online event.

2. The method of claim 1, wherein the aging period comprises a time period since an online event.

3. The method of claim 2, wherein the online event comprises an interaction within an application.

4. The method of claim 2, wherein the online event comprises an interaction within a plurality of applications.

5. The method of claim 2, wherein the online event comprises a change to an online project.

6. The method of claim 1, further comprising moving the connection to a second group.

7. The method of claim 6, wherein the connection has less access after moving the connection to the second group.

8. The method of claim 1, further comprising alerting the user of an impending removal.

9. The method of claim 1, further comprising inviting the user to adjust the aging period.

10. The method of claim 1, further comprising receiving an election from the user to participate in a removal program.

11. The method of claim 1, further comprising providing to the user an opportunity not to participate in a removal program.

12. A system, comprising:
an assignment engine, configured to
provide a first group; and
to assign a connection to the first group;
a tracking engine, configured to track online events involving a user and the connection; and
a removal engine, configured to remove the connection from the first group upon passage of an aging period associated with an online event.

13. The system of claim 12, wherein the aging period comprises a time period since an online event.

14. The system of claim 13, wherein the online event comprises an interaction within an application.

15. The system of claim 13, wherein the online event comprises an interaction within a plurality of applications.

16. The system of claim 13, wherein the online event comprises initiation or receipt of a telephone call.

17. The system of claim 12, further comprising moving the connection to a second group.

18. The system of claim 17, wherein the connection has less access after moving the connection to the second group.

19. A computer readable medium storing computer executable instructions that when executed implement a method, the method comprising:
providing a first group;
assigning a connection to the first group;
tracking online events involving a user and the connection; and
removing the connection from the first group upon passage of a time period since an online event.

20. The medium of claim 19, further comprising moving the connection to a second group and wherein the connection has less access to the user after moving the connection to the second group.
